(19) United States
(12) Patent Application Publication
(10) Pub. No.: US 2013/0018673 A1
(43) Pub. Date: Jan. 17, 2013

(54) Systems and Methods for Tracking Time in Scanning-Based Transactions

(71) Applicant: Nathan James Rubin, Bonita, CA (US)

(72) Inventor: Nathan James Rubin, Bonita, CA (US)

(21) Appl. No.: 13/547,389

(22) Filed: Jul. 12, 2012

Related U.S. Application Data
(60) Provisional application No. 61/507,231, filed on Jul. 13, 2011.

(51) Int. Cl. G06F 17/00; G06Q 50/24; G06Q 50/22

(52) U.S. Cl. 705/3; 235/377; 705/2

(57) ABSTRACT

Provided are systems and methods to measure time between scanner-based transactions and furthermore, the software and hardware required to do so. These systems can be used to track the location of high risk patients and alert staff if any issue arises. This system enables location, attributes, medications, and other vitals of patients to be tracked and stored.

### FIELD OF THE INVENTION

The present disclosure generally relates to scanning transactions, e.g., scanning bar code labels or radio-frequency identification (“RFID”) tags with a mobile scanning device, and more specifically to systems and methods for tracking and measuring units of time that elapse between completed scanned transactions.

### SUMMARY

Systems, methods and computer programs for tracking and measuring units of time that elapse between completed scanning-based transactions, where the scanning-based transactions may be completed by the use of a mobile scanning device to scan a bar code label or RFID tag and communicate it to a server with database software. This system is designed to improve patient safety and caregiver accountability through the use of timely, accurate and secure data collection and reporting. The system can scan and track a number of patients or objects at one time.

### BRIEF DESCRIPTION OF THE DRAWINGS

The embodiments are illustrated by way of example and not limitation in the figures of the accompanying drawings in which like references indicate like elements.

FIG. 1 is a diagram illustrating an example system for tracking time in scanning-based transactions.

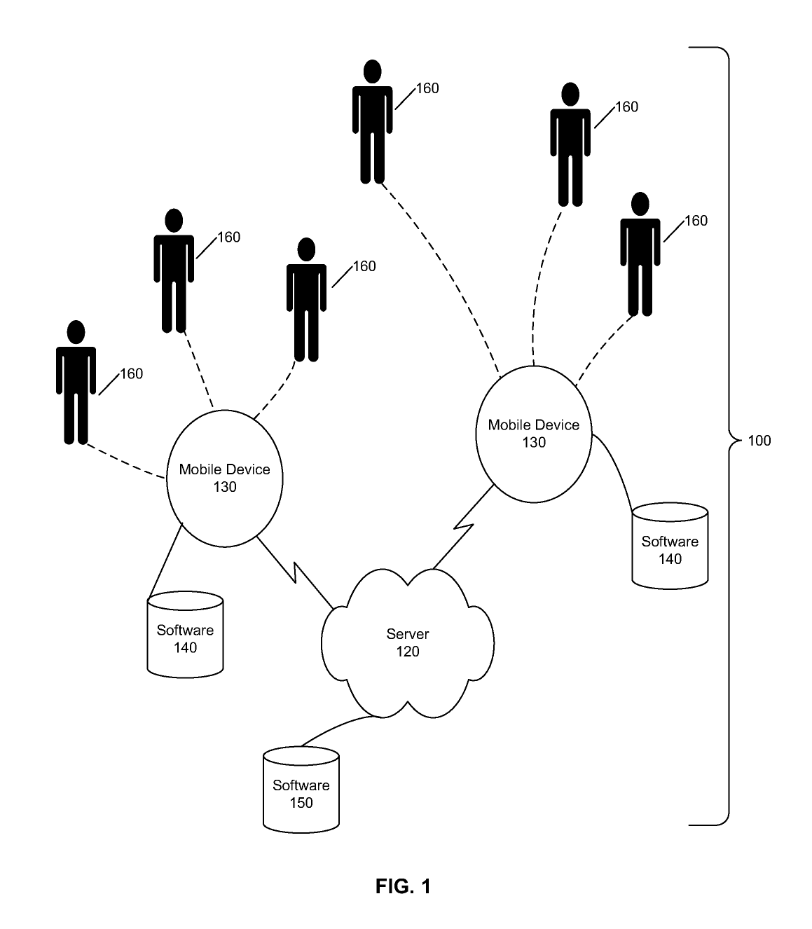

FIG. 2 is a diagram of the patient check system components.

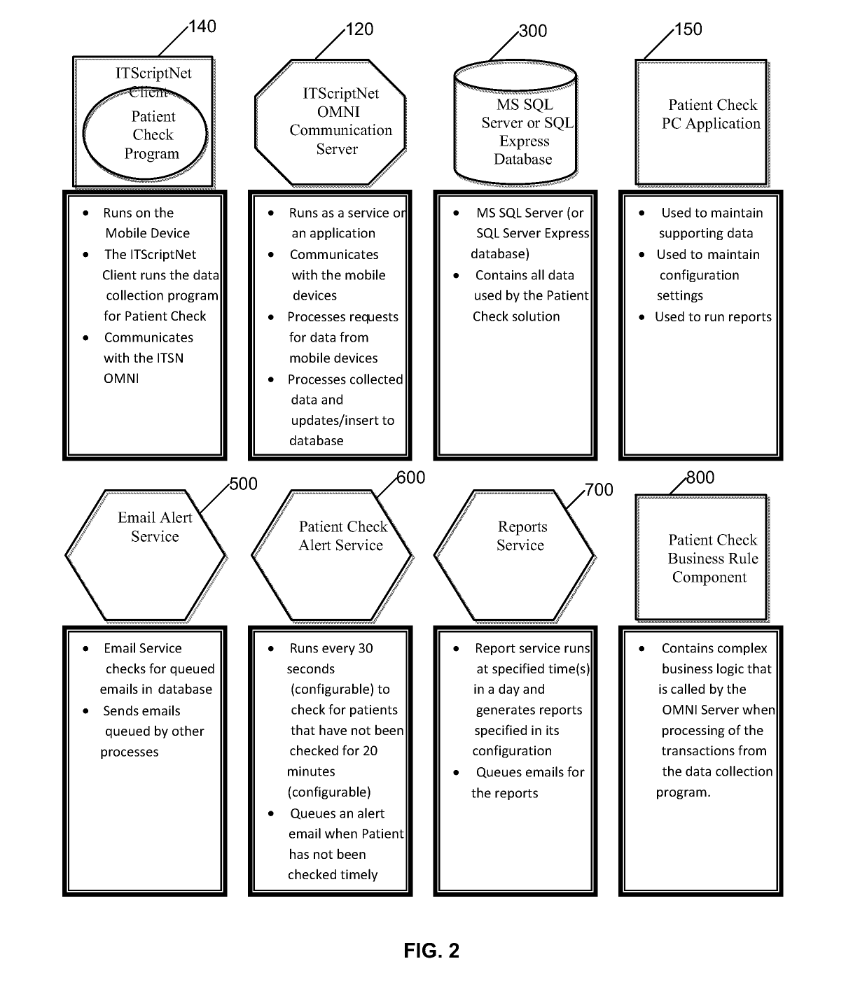

FIG. 3 is a flow chart of the patient check information.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment, and such references mean at least one. The use of headings herein is merely provided for ease of reference and shall not be interpreted in any way to limit this disclosure or the following claims.

Reference in this specification to “one embodiment” or “an embodiment” or the like means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not other embodiments.

The present application relates to systems, methods and computer programs for tracking and measuring units of time that elapse between completed transactions or scanning-based transactions, where a transaction may be defined as the use of a mobile scanning device to scan a bar code label, RFID or other radio tracking tag adhered to an object or a wristband being worn by an individual, plus the scanning of the ID badge of the person responsible for completing the transaction, or the scanning of a bar code label or other tag that identifies the location where the transaction is taking place. The system involves the integration of custom software applications, computers and computer peripherals, including handheld mobile devices capable of scanning and generating bar code labels and/or RFID tags and also capable of displaying digital imagery. Devices such as wireless network transponders, transceivers and identification badge and label printers may also be utilized.

Bar code and RFID radio frequency scanning technologies are not mutually exclusive. Both technologies can be used concurrently as required by the end-user. Multiple individuals and or objects can be scanned during a given round of transactions, yet the measurement of time elapsed is unique to each specific individual or object. Once a unique transaction is completed, the time clock is reset and the units of time that have elapsed are tracked and measured until the completion of the following unique transaction. Transactions may be completed within pre-defined time intervals while information is displayed on the handheld device, showing objects or individuals that have not been identified and scanned within the established period of time. If a transaction has not been completed within the allotted amount of time, automated email alerts are sent out to pre-determined recipients who can then take action to ensure the completion of the transaction. Once the transaction is completed, the clock resets for that specific object or individual. Transaction information is recorded and stored in a database for retrieval through automated pre-defined daily reports or user-defined reports that can be generated at any time.

FIG. (“FIG.”) 1 is a high level diagram of an example of system 100. A single system 100 includes a server 120 which can be a computer loaded with unique software entitled Patient Check PC Application 150, one or more mobile devices 130 in communication with the server 120, unique software 140 which can be ITSriptNet client software loaded on each of the mobile devices 130. The mobile devices 130 being capable of scanning, and creating, barcodes and or other radio frequency tags which may be located on patients 160 or other objects. The mobile devices 130 also contain a resident camera which is capable of photographing patients 160. The user of each mobile device 130 can input information on the patient 160 or other item into the mobile device which is then processed in the software program 140. The mobile device 130 can communicate this patient information and photograph to a wireless printer, or to the server 120 tethered to a printer via local (wired) network, which can then print this on wristbands and/or tags with barcodes or radio tages which can be placed on objects and or patients 160.

Although the present system 100 ultimately permits the user to track individuals or objects, the characteristic that differentiates this present system 100 from other tracking systems or applications is that it employs technology that actually tracks units of time that are elapsing between completed transactions in a real-time environment. While the present application can be used for any purpose or within any scenario or setting where identification and tracking are the ultimate combined goals, the idea for the invention was inspired by the reality of ever-increasing regulatory standards enacted to insure the safety of “at-risk” patients in psychiatric facilities. These patients 160 are at risk of committing suicide or severely harming themselves or others and regulatory standards have been set in place where care providers are obligated to identify and physically check each patient 160 every “x” number of minutes. “Q x” is the term used within the healthcare environment to identify mandatory checks in intervals of time, where “x” can be any number of minutes. In a specific case provided as an example, each patient must be checked every 15 minutes, or “Q 15.”

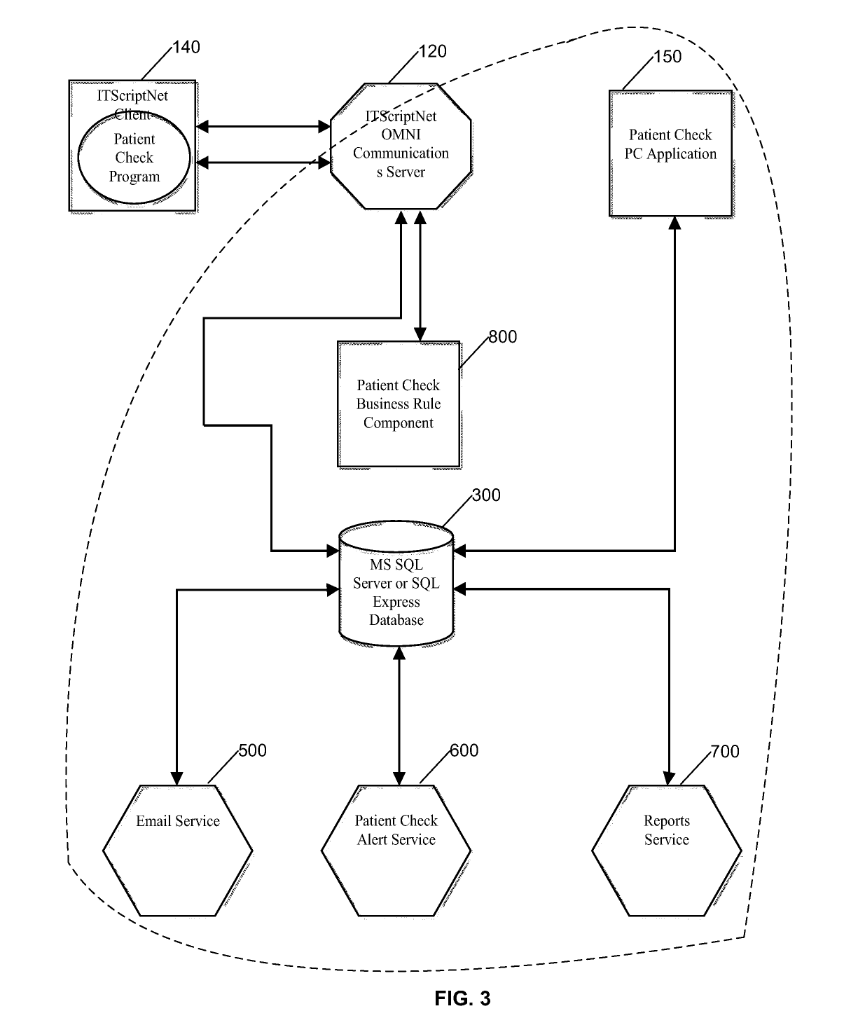

Referencing FIG. 3, the present system involves the use of either bar code or RFID radio technology for identifying and scanning individuals and objects. The end-user determines which methodology is to be used for scanning based upon cost considerations and the environment within which the invention will be used. The most unique attribute of the invention is not the hardware used to complete transactions, but rather the software components in combination with the hardware that integrate with each other and the various hardware components to insure timely scans and alerts. Multiple patients 160 can be scanned with a mobile device 130 where software 140 on the mobile device has a listing of the patients and keeps track of the time elapsed for each individual patient which it communicates to the server 120. The mobile devices 130 communicate with each other through the server 120 and if one mobile device scans patient A it remotely communicates this to the server 120. All devices 130 in the system 100 sync with the server every 10 to 30 seconds. Once this update occurs the other devices are aware that patient A has been scanned and their software 140 is updated. All of this information regarding the scanning is communicated back to the server 120 which collects, stores and compiles the data. Pre-defined scanning intervals are established and the software measures, in real-time, the value of time units elapsed after a scanning transaction has taken place. A mobile scanning device 130 captures a scanning transaction and immediately begins to count the units of time that elapse from the moment of that transaction specific to the individual or object that has been scanned. The mobile device 130 then displays how much time has elapsed since the last scanning transaction on each patient 160 or object and alerts the user when the pre-defined time interval is nearing completion. This permits the user to affect a scan of that individual or object and comply with the standard set in place.

In one embodiment, the system may be comprised of some or all of the following components: an ITSriptNet client 140, an ITSN OMNI Communications Server 120, an SQL Server® or SQL Express Database 130, resident on the server 120, a PC application 150, an email service 500, a patient check alert service 600, a report service 700, and a business rule component 800. All residents on the server and communicable to the mobile devices 130.

The software 140 runs on a mobile device 130 which can be a hand-held wireless scanner with digital imagery, Bluetooth, photo taking, and multiple communications capabilities. The client runs the software 140 such as the IT ScriptNet on the mobile device(s) 130 and communicate(s) with the ITSN OMNI Communications Server 120 in other embodiments different types of servers may be used on a standard 802.11x wireless network.

The Server 120 runs software 130. It communicates with mobile devices 130 via socket connections over standard 802.11x protocol, processes requests for data from other mobile devices 130, and processes collected data, which involves inserting the collected data into the database 300 and executing business logic to update several other data tables to fully propagate the effect of the collected data.

The SQL Server® which holds a SQL Express Database 300 is used to accommodate the heavy data capture activity and process data received from the mobile devices 130 and communicate it to the mobile devices 130. The database contains 300 all data used by the system 100 and in one embodiment is comprised of the following tables:

(a) Patients—ID#, first name, last name, Date of Birth, doctor, gender, level of care, wing, room, status, condition, photo, last-checked timestamp.

(b) Transactions—Some of the database fields include: admission, check, discharge and room movement. The transactions also update the master patient records with the currently assigned room, last check timestamp, condition and status (admitted/discharged)—fields: employee ID, wing/location, transaction type, patient ID, condition (Check only), status (admission and discharge only), room (move only), timestamp. Transactions records are used to form a complete activity history involving the patient.

(c) System users—ID #, first name, last name, authorized processes stored in different but linked files.

(d) Unit/location—ID #, description.

(e) Condition—list of conditions that are used when doing a Patient Check to indicate the current condition of the patient.—ID, Description.

(f) Assigned locations—List of the assigned locations where patients are allowed to be—ID, assigned unit/location allowed.

(g) Email recipients—ID, email address

(h) Time interval parameters—are stored in the configuration table and identify the units of time that can transpire between transactions and the total time allowed to complete all transactions before going into ‘review’ mode.

(i) Precautions—are predefined and reside in a table which is accessed on the mobile devices when “rounds” caregivers are conducting Patient Checks. Any such precautions whether physical or behavioral are displayed when checking a patient so that the caregiver can use the necessary care to avoid triggering an event.

The PC Application is used to maintain general configuration settings, maintain supporting data, and generate reports.

The Email Service checks for emails queued in the database and sends emails queued by other processes.

Referring to FIG. 3, the Patient Check Alert Service 140 runs on a regular interval which can be configured. In one embodiment, this is every 30 seconds to check for transactions that have not been completed during a given round. The round time limit is configurable and, in one embodiment, is set at 20 minutes. This service queues an email alert 500 when a transaction has reached the maximum time limit for the completion of a round. For security there is a second alert timing threshold used by the system 100.

The Report Service 700 resides in the PC Application software 150 and generates pre-defined reports to run automatically at specified times during the day. The time and frequency of the reports are configurable values, however, the Report Service 700 also allows for custom reports to be configured and run at any time.

The Business Rule Component 800 runs in the background and utilizes complex business logic that is accessed by the Server 120 when processing transactions from the data collection program.

This system 100 includes many unique attributes. Time units between transactions are measured in actual real time increments which are tracked. While systems and processes for tracking and identifying individuals, objects and processes abound, including those that can time-stamp a transaction and measure the amount of time between transactions, the present application relates to a method where time units between transactions are measured in actual real time increments and are tracked for the purpose of making sure that transactions are completed within pre-determined time intervals. As it relates to the specific example provided above, the inability to ensure compliance with Q 15 patient check or rounds standards can put at-risk patients in great danger. Patient safety is the primary focus of this application with risk management being a secondary benefit.

In this embodiment, rounds are conducted 24 hours around the clock and each patient 160 must be physically checked every 15 minutes, a patient check data collection program resides in each mobile handheld device (e.g., scanner), which displays a list of patients that have yet to be physically identified and checked (e.g., scanned) in a given location and within a specific time interval. If no patients have been checked, the mobile device 130 screen shows a list of all patients residing in the locations where the patient check rounds are being conducted. Two parameters which can be used by the program to calculate the time interval are: A) the number of minutes within which each patient must be checked, and B) the anchor time, which is typically set to midnight.

Once the anchor time has been set, the transaction interval start and stop times are determined based off the anchor time. Once a patient check round begins, patients in the grid are listed such that the patient with the longest time since last being checked is listed first. Color-coding the screen background is another method of reminding the rounds person that there are patients that have not been checked. In one embodiment patient names might be listed on a white background which can mean that those patients have already been checked and fall outside of the current time interval. Patient names who are listed on a different color background are those patients where ten minutes have elapsed since last being checked. The background changes to yet a third color for patients that have not been scanned during the last 15-20 minutes, and a fourth background color indicates that a patient has not been scanned for 25 minutes or more. The alert service scans the patients in the database and will queue an email alert when it detects a patient who has not been checked with the configurable maximum timing threshold or 20 minutes in this case. The email alerts are sent out to rounds supervisors or other key personnel who can then take the necessary measures to ensure that the patient is scanned. If a 25-minute email alert goes out, the severity of the issue can be elevated to code status where additional people are brought in to locate a patient through additional email alerts.

Once a patient is found, scanned and identified, the time interval for that patient starts again. A third visible cue can be added at the bottom of the patient check screen in the way of a hourglass. This is a simple way for a rounds person to see how much time has elapsed since the beginning of the round. The hourglass runs independently from the patient scans and runs off an anchor time. Once the last patient has been scanned, a new round begins and the rounds person can see which patients need to be checked first based on the color-coding method described above.

### Portable Data Collection Unit Process Flow

Once a patient's information is input into the main database 300 (see Admission below), the process flows as follows, but may not be limited to the order of screens presented:

### Screen #1

The mobile device 130 user scans a bar coded or RFID enabled identification badge (printed via a separate system) or manually enters his/her employee ID. The user's ID information is validated against a list generated from the System User table. If invalid, a message will be displayed indicating such and requiring a valid entry to move on. If the scanned or keyed in user information is valid, the system automatically displays Screen #2. The menu options displayed on Screen #2 depend entirely on the security clearance assigned to each mobile device user. Pressing of the exit button will exit the program and return the user to the main ITS criptNet menu.

### Screen #2

This screen displays a variety of menu options where the options shown are only those that are applicable to a user's clearance level. The complete list of options can include: Admission, Discharge, Room Move, Patient Check, Pharmacy set precautions or Re-print wristband. Upon selecting a user-validated process, the Process is populated with the appropriate process code—‘A’ for Admission, ‘D’ for Discharge, ‘M’ for Room Move and ‘C’ for Patient Check. Wristbands can only be re-printed by a System Supervisor. Pressing the Back (or Login) button returns the user to Screen #1.

### Screen #3

After the desired process is selected from Screen #2, this screen displays information that is necessary to complete the selected process. A banner across the top of the screen displays the name of the current process.

Wing/Location—scanned. This value will remain until the user selects the Clear button or returns to the Login screen.

### Screen #3 Processes

### Admissions

The patient's Chart Label from their admissions document is scanned. The assumption is made that the patient's information is entered into a medical records application, and a form can be printed that includes a single dimensional bar code that is linked to an admissions database or a two dimensional bar code or RFID tag containing the patient ID, name, wing and room assigned plus any other pertinent information. If such a form cannot be printed from the main admissions database, the patient's information can be input manually. Regardless of whether the information has been scanned in or captured manually, the information is parsed to the corresponding fields in the Patient Check SQL database.

The user then selects the option of taking an incoming patient's picture, on the mobile device 130, which takes the user to Screen #4. The picture taken can be communicated to the server 120 and placed is resident in the database 300 located on the server. The patient's picture can then be printed on the wristband along with the bar code or radio tag and will also show on the screen of the mobile device 130 when the wristband is scanned.

If the incoming patient's location or room number was not scanned in from the Patient's Chart, the user can enter the information manually at this point. A pre-defined dropdown list allows the user to select from a number of “conditions”, which identify the patient's condition upon being admitted to the facility.

A Menu button is used to take the user back to Screen #2.

A Next button is used to save the record and refresh this screen, allowing the user to remain in the Admission mode.

The information on the patient collected and imputted into the mobile device 130 wristband can be printed using the System's thermal label printer 170. The wristband is communicated back to the server 120 where it is compiled. The server 120 can then communicate this information remotely to a printer 170. The wristband can include a picture of the patient, either a single or two-dimensional bar code or an embedded RFID chip, the patient's full name, and other pertinent information such as a Medical Record number and/or patient ID number. The information displayed on the wristband is at the discretion of the user.

Once a wristband is printed, the patient enters the transaction queue and the System begins to track and measure time units elapsed from the moment the wristband is printed.

### Discharge

To discharge a patient, the user selects the “Discharge” process and scans the patient's wristband. If the information scanned on the wristband is valid, the patient's name and picture are displayed on the mobile scanner's display, which gives the user two methods of instant identification.

Pressing the Menu button takes the user back to the Screen #2.

Pressing the Next button will save the record and refresh this screen while staying in the Discharge mode. Upon pressing the Next key again, the patient is taken out of the transaction queue. When you press the Next/Save button, the transaction is recorded and transmitted to the server. the screen goes back to the main menu (Screen 1).

### Patient Check

For a patient check to be valid and complete the patient must be observed and the wristband must be scanned. When bar codes are used, they are printed around the wristband, such that the patients can be scanned regardless of the position they are found in. RFID enabled wristbands can be scanned from a distance so the patients position is not an issue.

To comply with regulatory standards requiring that, at least, two forms of identification be used when identifying a patient, upon conducting a validated scan of the patients wristband, the patient's name and picture are displayed on the mobile scanner's display, thus satisfying that requirement.

The system validates the patient's location against the information in the SQL database FIG. 3 (300) and, if the patient's present location is NOT an authorized location, an alert is displayed on the mobile device. The message will need to be cleared by a person authorized to do so in order to continue with the transaction. If there are no issues with the patient's location, the user will then select from a drop-down menu, which contains a list of pre-defined Conditions to report the patient's condition at the time of the check. The user has the option to add any notes to further describe a condition not displayed in the drop-down menu. The Menu key will take the user to the previous menu. The Next key saves the transaction and refreshes the screen, thus completing the patient check and taking the user back to Screen #2.

If the patient is to be moved to a new location, a room move must be performed. To affect a room move, the user must scan the patient's wristband. If valid, the patient's name and picture are displayed on the mobile scanner's screen. The patient's current location and room will be displayed. Fields for New Location and New Room will also be displayed. The Menu key takes the user back to Screen #2. The Next key saves the record and refreshes this screen, thus completing the room move, while staying in the Room Move mode.

FIG. (“FIG.”) 2 is a flow diagram of the patient check system 100 showing how the information flows within the system. The information flow system includes the following modules the patient check software 140, the communication server 120, the business rule component 800, express database 300, the email service 500, the patient check alert service 600, the patient check PC application 150, and reports service 700. The patient check software 140 communicates with the communication server 120. The patient check program 140 sends data to the communications server 120 and requests and receives data from the communication server 120 this data is stored in the database 300. The communication server 120 communicates directly with the business rule component 800 and express database 300. The communication server 120 calls into the business rule component 800 to initiate the complex logic that occurs after the transactions are sent to the database 300 so that all necessary updates are made to the database 300. The OMNI server 120 also retrieves data from the database 300 on behalf of the portable data collections program. The express database 300 is in direct communication with the business rule component 800, the communication server 120, the patient check PC application 150, the report service 700, the patient check alert service 600, and the email service 500. The email service 500 scans the database 300 for emails that have been queried in the queue email table and then sends the corresponding email to the database 300. Email service will read from the Database and send emails to the recipient, it will also record in the Database if it was successfully sent. In one embodiment of the email service 500 will try a maximim of 6 times. The patient check alert service 600 scans the patients in the database 300 and will queue an email alert when it detects a patient who has not been checked within the configurable timing threshold and transmits this information to the database 300. The report service 700 generally reports and queues emails for users who need reports and passes these directly to the database 300 which is in communication with the other modules. The patient check application 150 makes the data from the database available to end users. The user modify the data in the database from the database maintenance screen. Data is viewed from various screens within the application and with reports that are integrative. The patient application 150 communicates directly with the database which is in communication with the other modules listed above.

Referring to FIG. 3 the patient check timing flow is displayed. In this system the patient check system 100 requests updated patient information from the communication server 120. The communication server 120 then communicates with the business rule component 800 or the database. The database 300 communications with the patient check application 150 so that it can configure the timing parameters from the PC application. The patient alert service 600 communicates back to the database after it scans the patients in the database and detects a patient who has not been checked within the configurable timing threshold. The database 300 can then send this information to the email service 500 to queue an email alert when it detects an issue.

### Pharmacy

In an embodiment of this system, a pharmacy process can be performed. The Pharmacy process allows the user to identify the patient and validate that the patient information and prescribed medication are a match. To validate and administer the correct medication in the dosage prescribed, the user scans the patient's wristband. If valid, the patient's picture will be shown on the mobile scanner's screen. A bar code or RFID enabled label that identifies the medication and dosage to be administered is then scanned and the information is validated against the patient's record where medication information is stored. To further validate against the patient's record the user then enters the dosage to be administered. Using the Menu button takes user back to Screen #2. Using the Next button saves the record and refreshes this screen, thus completing the process of administrating medicine, while staying in the Pharmacy mode.

An option to go to Screen #5 is available on any of the process screens listed above. Screen 4 is used solely to photograph the patient. The photograph is stored in the SQL database and will be displayed on the mobile scanner's screen at any time when a patient's ID wristband is scanned. The patient's photo is also displayed in reports. Screen 5 displays a review grid showing a list of patients assigned to a given area that have not been scanned within the designated timeframe. The grid will contain the patient's name, location and time of last check. Use of the Check button takes the user directly to Screen #3 and into patient check mode if the user's security clearance allows it. If not, the user is taken back to Screen #2. Use of the Menu button also takes user back to Screen #2. Use of the Refresh button enables the user to retrieve a new list of patients not scanned within the designated timeframe. Screen 6 is used solely to re-print a patient's wristband. A grid will display the names and locations of all the patients in a given unit. The user selects the patient for which a new wristband is necessary and can print the wristband upon using the print button. Only select users will be authorized to reprint a patient wristband.

An embodiment of this system also has the availability of one or more report systems. Several reports have been developed using a commercially available tool called Crystal Reports. The main function of the Report Service is to serve as the component that emails the daily transaction report callable from the mobile units. Pre-defined Reports available from the PC Application include but are not limited to the following:

Current Patient List—Provides a list of patients currently admitted showing their current unit, room and last time they were scanned. Parameters will include showing the list for a chosen unit or for a single patient.

Transaction history—shows a history for a given time period of all the transactions captured. The report user can select the way the report is to be grouped. Options are by unit location, patient, device user, and status (admission, discharge, move or check).

Date range, unit location, patient, device user and process can be used to filter the report. All of reports can be used in conjunction with one another. The sort order will be by patient's last name.

Automatic Daily Activity—each day at a specified time, as entered in the Time Interval database maintenance screen, a report is generated showing the prior 24 hours of activity by patient ID (admissions, discharges, check scans, room moves). The report is grouped by patient ID and name displayed with columns for Employee ID (to show who entered the record), process, location, and date/time stamp.

List of employees—parameter for including and excluding security tokens

List of locations—including the locations a patient is allowed to be in when assigned to a particular location.

### PC Application

An embodiment of this system also has a PC application. This application collects, stores and processes the data collected. This PC application could have menu items for the following:

Database Maintenance screens—that allow the input and maintenance of patients, employees, locations, time intervals, conditions and email recipients. See the SQL Database section for fields.

Reports Screen—Allows user to select from a list of available reports. Includes a screen where options for grouping and filtering are presented.

Purge—in an environment where 100 patients are scanned every 15 minutes, 9,600 records would be created every day, which totals 288,000 per month. Allows for the purging of records three years old to be purged after user has backed up the data to an independent storage device.

An embodiment may also include an e-mail queue server. This e-mail queue server can send alerts indicating that a patient has not been checked within the specified time interval. These alerts are key to insuring patient safety. The e-mail utility triggers the sending of e-mail and manages the delivery of messages to designated users. It is driven by instructions on when to send an alert, for example checking and comparing the last time a patient has been scanned to the current time and if the maximum time limit has been exceeded, e-mail alerts are sent out to designated users containing the patient's information. The list of user addresses and clearance levels are stored in a table in the SQL database and are maintained through the use of the PC Application. If a message does not make it initially to its intended party the utility will attempt additional sends until the message is delivered or a specified period of time has lapsed. The E-mail Queue Server Engine is driven by readily available e-mail queue services that have been configured for use with the Patient Check application.

Those of skill will appreciate that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, units, blocks, modules, and steps have been described above generally in terms of their functionality. Whether such functionality is implemented as hardware or software depends upon the particular system and design constraints imposed on the overall system. Skilled persons can implement the described functionality in varying ways for each particular system, but such implementation decisions should not be interpreted as causing a departure from the scope of the invention. In addition, the grouping of functions within a unit, module, block or step is for ease of description. Specific functions or steps can be moved from one unit, module or block without departing from the invention.

The various illustrative logical blocks, units, steps and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the embodiments disclosed herein can be embodied directly in hardware, in a software module (or unit) executed by a processor, or in a combination of the two. A software module can reside in RAM memory, flash memory, ROM memory, EPROM memory, EEPROM memory, registers, hard disk, a removable disk, a CD-ROM, or any other form of machine or computer readable storage medium. An exemplary storage medium can be coupled to the processor such that the processor can read information from, and write information to, the storage medium. In the alternative, the storage medium can be integral to the processor. The processor and the storage medium can reside in an ASIC.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter, which is broadly contemplated by the present invention. It is further understood that the scope of the present invention fully encompasses other embodiments that may become obvious to those skilled in the art.

1. A system for tracking and measuring units of time that elapse between scanning-based transactions, comprised of:
one or more mobile devices capable of scanning bar codes and radio tags, collecting data and transmitting data,
one or more servers loaded with software, in remote communication with the one or more mobile devices,
a database resident on the one or more servers which is capable of compiling and collecting data received from the mobile devices,
a software program loaded on the one or more mobile devices which tracks time between the scanning of each bar code or radio tag resulting in a transaction, wherein the software program transmits transaction information to the one or more servers which communicate with the other mobile devices and send an alert when a specified time is reached.

2. The system of claim 1 wherein the time is reset for a bar code or radio tag once the tag is scanned.

3. The system of claim 1 wherein the transactions are recorded and stored in the database and can be retrieved to create reports.

4. The system of claim 1 which counts units of time elapsed after a transaction has been initiated and displays the time elapsed.

5. A method with at least one mobile device communicating wirelessly with at least one server, wherein the mobile device:
is programmed to input and collect patient data and track time on multiple patients by way of bar codes or radio tags scanning and communicate this information remotely to a server,
contains software which can read and process bar codes and radio tags and collect the patient data therefrom,
contains a digital display capable of displaying imagery with the patient information, photograph, and time elapsed from last scan,
is capable of taking photographs and communicating this, and patient information, to a printer to print thermal bar or radio tags with photographs and patient information,
transmits the patient data and tracking time to the sever which collects, processes and stores the information,
receives alerts from the server when a specified time has been reached after the last scan.

6. The method of claim 6, wherein the time is reset for a bar code or radio tag once the tag is scanned.

7. The method of claim 6 wherein the transactions are recorded and stored in the database and can be retrieved to create reports.

8. The method of claim 6, which can be used to validate patient information and prescribed medications.

9. The method of claim 6, which will display a grid showing a list of patients assigned to a given area which have not been scanned within the designated timeframe.

10. The method of claim 6, which includes an e-mail queue server to send an alert that a patient has not been scanned.
